(19) United States
(12) Patent Application Publication
(10) Pub. No.: US 2023/0077830 A1
(43) Pub. Date: Mar. 16, 2023

(54) METHOD, ELECTRONIC DEVICE, STORAGE MEDIUM AND PROGRAM PRODUCT FOR SAMPLE ANALYSIS

(71) Applicant: NEC CORPORATION, Tokyo (JP)

(72) Inventors: Li QUAN, Beijing (CN); Ni ZHANG, Beijing (CN)

(73) Assignee: NEC CORPORATION, Tokyo (JP)

(21) Appl. No.: 17/943,762

(22) Filed: Sep. 13, 2022

(30) Foreign Application Priority Data
Sep. 14, 2021 (CN) 202111075280.9

(51) Int. Cl. G06N 20/00; G06V 10/776; G06V 10/778

(52) U.S. Cl. CPC G06N 20/00; G06V 10/776; G06V 10/7784

(57) ABSTRACT

Embodiments of the present disclosure relate to a method, an electronic device, a storage medium and a program product for sample analysis. The method comprises: obtaining a sample set, the sample set being associated with annotation data; processing the sample set with a target model to determine prediction data for the sample set and confidence of the prediction data; determining accuracy of the target model based on a comparison between the prediction data and the annotation data; and determining a candidate sample which is potentially inaccurately annotated from the sample set based on the accuracy and the confidence. In this way, a potential inaccurately annotated sample may be efficiently screened out.

### FIELD

Embodiments of the present disclosure relate to the technical field of artificial intelligence, and more specifically, to a method, an electronic device, a computer storage medium and a computer program product for sample analysis.

### BACKGROUND

With the constant development of computer technology, machine learning models are being widely used in various aspects of people's life. During the training process of the machine learning model, the performance of the machine learning model is directly determined based on training data. For example, regarding image classification models, accurate classification annotation data is the basis for obtaining high-quality image analysis models. Therefore, people expect to improve the quality of sample data so as to derive a more accurate machine learning model.

### SUMMARY

Embodiments of the present disclosure provide a solution for sample analysis.

According to a first aspect of the present disclosure, a method is proposed for sample analysis. The method comprises: obtaining a sample set, the sample set being associated with annotation data; processing the sample set with a target model to determine prediction data for the sample set and confidence of the prediction data; determining accuracy of the target model based on a comparison between the prediction data and the annotation data; and determining, from the sample set based on the accuracy and the confidence, a candidate sample which is potentially inaccurately annotated.

According to a second aspect of the present disclosure, an electronic device is proposed. The device comprises: at least one processing unit; at least one memory coupled to the at least one processing unit and storing instructions for execution by the at least one processing unit, the instructions, when executed by the at least one processing unit, causing the device to perform acts, comprising: obtaining a sample set, the sample set being associated with annotation data; processing the sample set with a target model to determine prediction data for the sample set and confidence of the prediction data; determining accuracy of the target model based on a comparison between the prediction data and the annotation data; and determining, from the sample set based on the accuracy and the confidence, a candidate sample which is potentially inaccurately annotated.

According to a third aspect of the present disclosure, a computer-readable storage medium is provided. The computer-readable storage medium comprises computer-readable program instructions stored thereon, the computer-readable program instructions being used for performing a method according to the first aspect of the present disclosure.

According to a fourth aspect of the present disclosure, a computer program product is provided. The computer program product comprises computer-readable program instructions, which are used for performing a method according to the first aspect of the present disclosure.

This Summary is provided to introduce a selection of concepts in a simplified form that are further described below in the Detailed Description. This Summary is not intended to identify key features or essential features of the present disclosure, nor is it intended to be used to limit the scope of the present disclosure.

### BRIEF DESCRIPTION OF THE DRAWINGS

Through the more detailed description of example implementations of the present disclosure with reference to the accompanying drawings, the above and other objects, features and advantages of the present disclosure will become more apparent, wherein the same reference numerals typically represent the same components in the example embodiments of the present disclosure.

FIG. 1 shows a schematic view of an environment in which embodiments of the present disclosure may be implemented;

FIG. 2 shows a schematic view of the process of analyzing inaccurate annotation data according to embodiments of the present disclosure;

FIG. 3 shows a schematic view of the process of analyzing abnormal distribution samples according to embodiments of the present disclosure;

FIG. 4 shows a schematic view of the process of analyzing corrupted samples according to embodiments of the present disclosure;

FIG. 5 shows a flowchart of the process of analyzing samples with negative impact according to embodiments of the present disclosure; and

FIG. 6 shows a schematic block diagram of an example device which is applicable to implement embodiments of the present disclosure.

### DETAILED DESCRIPTION OF IMPLEMENTATIONS

Some preferable embodiments will be described in more detail with reference to the accompanying drawings, in which the preferable embodiments of the present disclosure have been illustrated. However, the present disclosure can be implemented in various manners, and thus should not be construed to be limited to embodiments disclosed herein. On the contrary, those embodiments are provided for the thorough and complete understanding of the present disclosure, and completely conveying the scope of the present disclosure to those skilled in the art.

The term “comprise” and its variants used here are to be read as open terms that mean “include, but is not limited to”. Unless otherwise specified, the term “or” is to be read as “and/or.” The term “based on” is to be read as “based at least in part on”. The terms “one example implementation” and “one implementation” are to be read as “at least one implementation.” The term “another implementation” is to be read as “at least one other implementation.” The terms “first”, “second” and the like may refer to different or the same objects. Other definitions, explicit and implicit, might be included below.

As described above, with the constant development of computer technology, machine learning models are being widely used in various aspects of people's life. During the training process of the machine learning model, the performance of the machine learning model is directly determined based on training data.

However, for training data, some low-quality training samples might cause a significant impact on the performance of models. One typical class of low-quality samples is inaccurately annotated samples, which have inaccurate annotation data. Typically, some model training processes rely on results of manual annotation to build a training dataset, and such manual annotation results however might be inaccurately annotated. For example, regarding an image classification task, some samples might be associated with inaccurate classification annotations, which will directly affect the accuracy of image classification models.

Another typical class of low-quality samples is samples with abnormal distribution, which means that the samples are quite different from normal samples for training in the sample set. Still taking image classification model as an example, an image classification model is trained to classify images of a cat to determine the breed of the cat. If training image samples include images of other types of animals, such image samples may be regarded as abnormal distribution samples. Abnormal distribution samples included in the training dataset will also affect the performance of machine learning models.

A further typical class of low-quality samples is corrupted samples, which refer to samples superimposed with artificial or non-artificial corruption noises over the normal samples. Still taking image classification models as an example, an image classification model is trained to classify images of a cat to determine the breed of the cat. If training image samples include blurred cat images, then such image samples may be regarded as corrupted samples. Part of corrupted samples included in the training dataset might have a negative impact on the training of machine learning models, which are also referred to as corrupted samples with negative impacts.

In addition, the low-quality training data/samples may be data that is helpless in improving the performance of model training.

According to embodiments of the present disclosure, a solution is provided for sample analysis. In the solution, a sample set with associated annotation data is firstly obtained, and the sample set is processed with a target model to determine prediction data for the sample set and confidence of the prediction data. Further, the accuracy of the target model is determined based on a comparison between the prediction data and the annotation data, and a candidate sample which is potentially inaccurately annotated is determined from the sample set based on the accuracy and the confidence. In this way, embodiments of the present disclosure can more effectively screen out samples which might be inaccurately annotated from the sample set.

### Example Environment

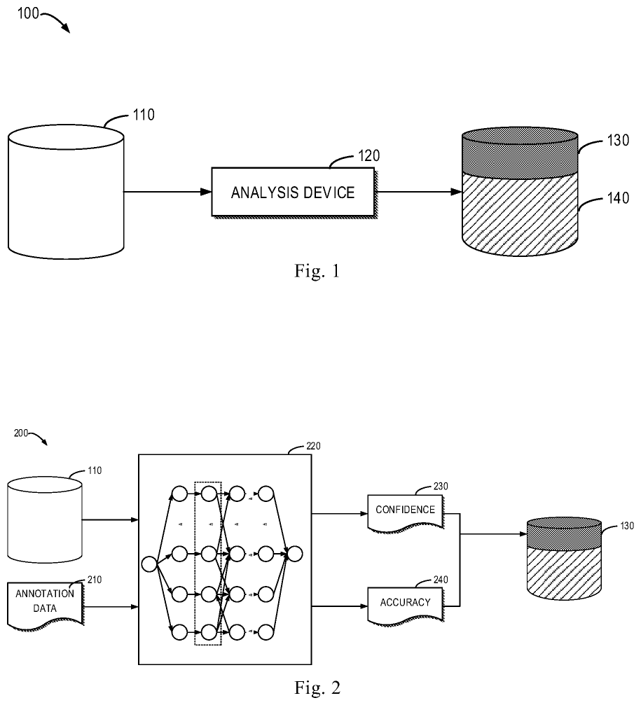

Embodiments of the present disclosure will be described in detail with reference to the drawings. FIG. 1 shows a schematic view of an example environment 100 in which multiple embodiments of the present disclosure can be implemented. As depicted, the example environment 100 comprises an analysis device 120, which may be used to implement the sample analysis process in various implementations of the present disclosure.

As shown in FIG. 1, the analysis device 120 may obtain a sample set 110. In some embodiments, the sample set 110 may comprise multiple training samples for training a machine learning model (also referred to as a target model). Such training samples may of any appropriate types, examples of which may include, but are not limited to, image samples, text samples, audio samples, video samples or other types of samples, etc. The sample set or samples may be an obtained dataset or data to be processed.

In the present disclosure, the target model may be designed to perform various tasks, such as image classification, object detection, speech recognition, machine translation, content filtering, etc. Examples of the target model include, without limitation to, various types of deep neural networks (DNNs), convolutional neural networks (CNNs), support vector machines (SVMs), decision trees, random forest models, etc. In implementations of the present disclosure, the prediction model may also be referred to as “machine learning model.” Hereinafter, the terms “prediction model”, “neural network”, “learning model”, “learning network”, “model” and “network” may be used interchangeably.

In some embodiments, the analysis device 120 may determine low-quality samples 130 included in the sample set based on the process of training the target model with the sample set 110. Such low-quality samples 130 may comprise one or more of the above-discussed inaccurately annotated samples, abnormal distribution samples or corrupted samples that cause a negative impact on the model.

In some embodiments, the low-quality samples 130 in the sample set 110 may be excluded, so as to obtain normal samples 140. Such normal samples 140 can for example be used to re-train the target model or other models so as to obtain a model with a higher performance. In other embodiments, the low-quality samples 130 in the sample set 110 may be identified and then further processed for converting into high-quality samples, and then the high-quality samples as well as the normal samples 140 are used to train the machine learning model.

### Analysis of Inaccurately Annotated Samples

Inaccurately annotated samples will be taken as an example of low-quality samples below. FIG. 2 shows a schematic view 200 of the process of analyzing inaccurately annotated samples according to embodiments of the present disclosure. As depicted, the sample set 110 may have corresponding annotation data 210. In some embodiments, the annotation data comprises at least one of target category labels, task category labels and behavior category labels associated with the sample set.

As discussed above, such annotation data 210 may be generated through artificial annotation, model automatic annotation or other appropriate ways. For some possible reasons, such annotation data 210 might have some errors.

In some embodiments, the annotation data 210 may be expressed in different forms depending on different task types to be performed by the target model 220. In some embodiments, a target model 220 may be used to perform classification tasks on input samples. Accordingly, the annotation data 210 may comprise classification annotations for various samples in the sample set 110. It should be understood that the specific model structure shown in FIG. 2 is merely exemplary and not intended to limit the present disclosure.

For example, the annotation data 210 may be classification annotations for an image sample set, classification annotations for a video sample set, classification annotations for a text sample set, classification annotations for a speech sample set, or classification annotations for other types of sample sets.

In some embodiments, the target model 220 may be used to perform regression tasks on input samples. For example, the target model 220 may be used to output the boundaries of particular objects in the input image sample (e.g., boundary pixels of a cat included in the image). Accordingly, the annotation data 210 may comprise annotated positions of boundary pixels.

As shown in FIG. 2, the analysis device 120 may process the sample set 110 with the target model 220 to determine prediction data for the sample set 110 and confidence 230 corresponding to the prediction data.

In some embodiments, the confidence 230 may be used to characterize the reliability degree of the prediction data output by the target model 220. In some embodiments, the confidence 230 may comprise the uncertainty metric associated with the prediction data determined by the target model 220, e.g., BALD (Bayesian Active Learning by Disagreement). It should be understood that a higher uncertainty characterized by the uncertainty metric indicates a lower reliability degree of the prediction data.

In some embodiments, the confidence 230 may be determined based on the difference between the prediction data and the annotation data. Specifically, the confidence 230 may further comprise the loss metric output after the target model 220 is trained via the sample set 110 and the labeled data 210, which, for example, may guarantee the difference between the prediction data and the annotation data. Such loss metric may be represented as a value of a loss function corresponding to a sample. In some embodiments, a larger value of the loss function indicates a lower reliability degree of the prediction data.

Further, as shown in FIG. 2, the analysis device 120 may further determine the accuracy 240 of the target model 220 based on a comparison between the prediction data and the annotation data 210. The accuracy 240 may be determined by the proportion of samples in which annotation data matches prediction data in the sample set 110. For example, if the sample set comprises 100 samples, and there are 80 samples in which the prediction data output by the target model 220 matches the annotation data, then the accuracy may be determined as 80%.

Depending on the task type performed by the target model 220, the matching between the prediction data and the annotation data may have different meaning. Taking a classification task as an example, the matching between the prediction data and the annotation data is intended to indicate that a classification label output by the target model 220 is the same as the classification annotation.

Regarding a regression task, the matching between prediction data and the annotation data may be determined based on a degree of the difference between the prediction data and the annotation data. For example, taking a regression task that outputs the boundaries of a specific object in the image as an example, the analysis device 120 may determine whether the prediction data matches the annotation data based on a distance from positions of a group of pixels included in the prediction data to positions of a group of pixels included in the annotation data.

For example, if the distance exceeds a predetermined threshold, it may be considered that the prediction data fails to match the annotation data. Otherwise, it may be considered that the prediction data matches the annotation data.

Further, as shown in FIG. 2, the analysis device 120 may determine candidate samples (i.e., the low-quality samples 130) from the sample set based on the confidence 230 and the accuracy 240. Such candidate samples may be determined as a sample with a possibility of having inaccurately annotated data.

In some embodiments, the analysis device 120 may determine a target number based on the accuracy 240 and the number of samples in the sample set 110. For example, taking the previous example, if the sample set 110 includes 100 samples, and the accuracy is determined as 20%, then the analysis device 120 may determine that the target number is 20.

In some embodiments, the analysis device 120 may further determine, based on the confidence 230, which samples in the sample set 110 are supposed to be determined as candidate samples. As an example, the analysis device 120 may rank the reliability degrees of the prediction results based on the confidence 230 in an ascending order and select the target number of samples according to the accuracy 240 therefrom as candidate samples that might have inaccurately annotated data.

In this way, embodiments of the present disclosure may select candidate samples that better satisfies the expected number without relying on prior knowledge of the accuracy of the annotation data (the prior knowledge is usually unavailable in practice). Therefore, it may be avoided that the number of selected candidate samples widely differs from the real number of inaccurately annotated samples.

In some embodiments, after candidate samples are determined, the analysis device 120 may further provide sample information associated with the candidate samples. The sample information may comprise information that indicates a possibility that the candidate samples have inaccurately annotated data. For example, the analysis device 120 may output the identification of samples that might have inaccurately annotated data, so as to indicate that such samples are potentially inaccurately annotated. Further, the analysis device 120 may output initial annotation data and predicted annotation data of the candidate samples.

In some embodiments, the analysis device 120 may further train the target model 220 only using the sample set 110 without relying on other training data. That is, before the target model 220 is trained via the sample set 110, the target model 220 may be in an initialized state, which has a relatively poor performance.

In some embodiments, the analysis device 120 may use the sample set to train the target model 220 for only one time. The one-time training means that after the sample set 110 is input into the target model, the model is automatically trained without manual intervention. In this way, labor costs and time costs may be significantly reduced over the traditional method of manually selecting some samples for preliminary training, using the initially trained model to predict other samples, and then iteratively repeating the steps of manual selection, training and prediction.

In order to directly train the target model 220 using only the sample set 110 and to select candidate samples, the analysis device 120 may train the target model 220 through an appropriate training method, so as to reduce the impact of samples with inaccurately annotated information on the training process of the target model 220.

In some embodiments, the analysis device 120 may train the target model 220 with the sample set 110 and the annotation data 210, so as to divide the sample set 110 into a first sample sub-set and a second sample sub-set. Specifically, the analysis device 120 may automatically divide the sample set 110 into the first sample sub-set and the second sample sub-set based on training parameters related to the training process of the target model 220. Such a first sample sub-set may be determined to include samples that are helpful for training of the target model 220, while the second sample sub-set may be determined to include samples that may interfere with training the model 220.

In some embodiments, the analysis device 120 may train the target model with the sample set 110 and the annotation data 210, so as to determine the uncertainty metric associated with the sample set 110. Further, the analysis device 120 may divide the sample set 110 into the first sample sub-set and the second sample sub-set based on the determined uncertainty metric.

In some embodiments, according to a comparison between the uncertainty metric and a threshold, the analysis device 120 may determine the first sample sub-set as comprising samples with the uncertainty metric less than the threshold, and determine the second sample sub-set as comprising samples with the uncertainty metric more than or equal to the threshold.

In some embodiments, the analysis device 120 may also train the target model 220 with the sample set 110 and the annotation data 210, so as to determine the training loss associated with the sample set 110. Further, the analysis device 120 may use a classifier to process the training loss associated with the sample set 110, thereby dividing the sample set 110 into the first sample sub-set and the second sample sub-set.

In some embodiments, the analysis device 120 may determine, as the training loss, a value of the loss function corresponding to each sample. Further, the analysis device 120 may use a Gaussian Mixture Model (GMM) as the classifier to divide the training set 110 into the first sample sub-set and the second sample sub-set according to the training loss.

Further, after the completion of dividing the sample set into the first sample sub-set and the second sample sub-set, the analysis device 120 may further use a semi-supervised learning method to retrain the target model based on the annotation data of the first sample sub-set as well as the second sample sub-set, without considering the annotation data of the second sample sub-set.

In this way, without relying on other training data than the sample set, embodiments of the present disclosure can train the target model only based on the sample set of samples with potential inaccurate annotation information, and further obtain candidate samples with potential inaccurate annotation information.

The process of using an image classification model to select candidate image samples with potential inaccurate image classification annotations will be described by taking an image sample set as an example of the sample set 110. It should be understood this is merely exemplary, and as discussed above, any other appropriate type of sample set and/or target model is also applicable to the above sample analysis process.

Regarding the image annotation process, either the annotating party or the training party that uses the annotation data to train the model may deploy the analysis device as discussed in FIG. 1 to determine the quality of the image classification annotation.

In some embodiments, the classification annotation may perform the classification annotation on one or more image areas in each image sample in the image sample set. For example, the annotating party might manually annotate multiple areas corresponding to animals in the image sample with classification labels corresponding to animal categories.

In some embodiments, the analysis device 120 may obtain such annotation data and the corresponding image sample set. Unlike directly using the image sample set as the sample set input into the target model, the analysis device 120 may further extract multiple sub-images corresponding to a group of to-be-annotated image areas and adjust sizes of the multiple sub-images so as to obtain the sample set 110 for training the target model.

Since the input image of the target model usually has corresponding size requirements, the analysis device 120 may adjust sizes of the multiple sub-images to required dimensions of the target model so as to facilitate the target model to perform processing.

After unifying the multiple sub-images to the required dimension, the analysis device 120 may determine sub-images which may be inaccurately annotated from the multiple sub-images based on the above-discussed process. Further, the analysis device 120 may provide an original image sample corresponding to the sub-image, as the feedback from the training party to the annotating party or as the quality check feedback from the annotating party to the specific annotating personnel.

In this way, embodiments of the present disclosure can effectively screen out areas (also referred to as annotation boxes) possibly with wrong annotation information from the multiple image samples with annotation information, so as to help the annotating party to improve the annotation quality or help the training party to improve the performance of the model.

### Analysis of Abnormal Distribution Samples

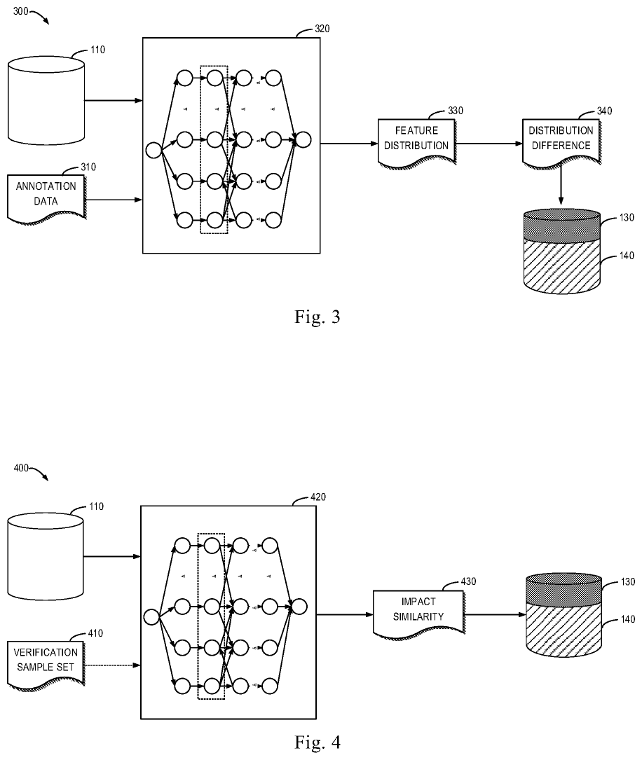

The process of analyzing abnormal distribution samples will be described by taking abnormal distribution samples as an example of low-quality samples and with reference to FIG. 3. This figure shows a schematic view 300 of the process of analyzing abnormal distribution samples according to some embodiments of the present disclosure. The sample set 110 may comprise multiple samples which may comprise the above-discussed abnormal distribution samples.

In some embodiments, the sample set 110 may have corresponding annotation data 310, which may comprise classification labels for various samples in the sample set 110.

As shown in FIG. 3, the analysis device 120 may train a target model 320 with the sample set 110 and the annotation data 310. Such a target model 320 may be a classification model for determining classification information of an input sample. It should be understood that the specific model structure shown in FIG. 3 is merely exemplary and not intended to limit the present disclosure.

After the completion of training of the target model 320, the target model 320 may output feature distributions 330 corresponding to multiple categories associated with the sample set 110. For example, the sample set 110 may comprise image samples for training the target model 320 to classify cats and dogs. Accordingly, the feature distributions 330 may comprise a feature distribution corresponding to the category “cat” and a feature distribution corresponding to the category “dog.”

In some embodiments, the analysis device 120 may determine a feature distribution corresponding to a category based on the following formula:

$${\hat{μ}}_{c} = \frac{1}{{N}_{c}} {\sum }_{i : {y}_{i} = c} f ( {x}_{i} ) , \hat{\sum } = \frac{1}{N} {\sum }_{c} {\sum }_{i : {y}_{i} = c} ( f ( {x}_{i} ) - {\hat{μ}}_{c} ) {( f ( {x}_{i} ) - {\hat{μ}}_{c} )}^{T} \qquad ( 1 )$$

wherein N_{c} represents the number of samples with the classification label c, xᵢ represents a sample in the sample set 110, yᵢ represents annotation data corresponding to the sample, and f( ) represents the processing procedure of the previous neural classifier in the softmax layer in the target model 320.

Further, as shown in FIG. 3, the analysis device 120 may determine a distribution difference 340 between the feature of each sample in the sample set 110 and the feature distribution 330. As an example, the analysis device 120 may calculate the Mahalanobis Distance between the feature of a sample and the feature distribution 330:

$$M ( x ) = {max}_{c} - {( f ( x ) - {\hat{μ}}_{c} )}^{T} {\hat{\sum }}^{- 1} ( f ( x ) - {\hat{μ}}_{c} ) \qquad ( 2 )$$

Further, the analysis device 120 may determine, as the low-quality samples 130, abnormal distribution samples in the sample set 110 based on the distribution difference 340. The analysis device 120 may further filter out the low-quality samples 110 from the sample set 110 to obtain the normal samples 140 for training or re-training the target model 320 or other models.

In some embodiments, the analysis device 120 may compare the distribution difference 340 with a predetermined threshold and determine a sample with the difference larger than the threshold as the abnormal distribution sample. For example, the analysis device 120 may determine a comparison between the Mahalanobis Distance determined based on Formula (2) and a distance threshold, so as to screen out abnormal distribution samples.

It should be understood that the process of screening out abnormal distribution samples as shown in FIG. 3 may be iteratively performed for predetermined times or until no abnormal distribution sample is output. Specifically, in the next iteration, the normal sample 140 determined in the previous iteration may further be used as a sample set for training the target model 320, and the process discussed in FIG. 3 continues.

In the above-discussed way, embodiments of the present disclosure can screen out possible abnormal distribution samples only by using the training process of the target sample set 110, which does not rely on high-quality training data for training the target model in advance. This can reduce the requirement on the cleanliness of training data and thus increase the feasibility of the method.

### Analysis of Corrupted Samples

The process of analyzing corrupted samples will be described by taking negative-impact corrupted samples as an example of low-quality samples and with reference to FIG. 4. This figure shows a schematic view 400 of the process of analyzing negative-impact corrupted samples according to some embodiments of the present disclosure. The sample set 110 may comprise multiple samples which may comprise the above-discussed negative-impact corrupted samples.

In some embodiments, the analysis device 120 may train a target model 420 with the sample set 110. If the target model 420 is a supervised learning model, the training of the target model 420 may require annotation data corresponding to the samples 110. On the contrary, if the target model 420 is an unsupervised learning model, annotation data might not be necessary. It should be understood that the specific model structure shown in FIG. 4 is merely exemplary and not intended to limit the present disclosure.

As shown in FIG. 4, the target model 420 may further comprise a verification sample set 410, and samples in the verification sample set 410 may be determined as samples having a positive impact on the training of the target model 420.

As shown in FIG. 4, the analysis device 120 may determine an impact similarity 430 between an impact degree of various samples in the sample set 110 on the training process of the target model 420 and an impact degree of the verification sample set 410 on the training process of the target model 420.

In some embodiments, the analysis device 120 may determine the variation of the value of the loss function associated with the sample over multiple iterations. For example, the analysis device 120 may determine the impact similarity between the sample z in the sample set 110 and the verification sample set z′ based on the following formula:

TracInIdeal(z,z′)=Σ_{t:z}_{ₜ}_{=z} [symbol] (wₜ,z′)− [symbol] (wₜ₊₁,z′) (3)

wherein t represents the number of iterations of the training, wₜ represents a model parameter in t iterations, [symbol] represents the loss function, z represents a sample in the sample set 110, and z′ represents the verification sample set 410. In this way, the analysis device 120 may calculate the impact similarity 430 between each sample in the sample set 110 and the verification sample set 410.

In some embodiments, Formula (3) may further be simplified as Formula (4), i.e., converted to the product of gradient changes:

$$TracInCP ( z , {z}^{′} ) = {\sum }_{i = 1}^{k} {η}_{i} ∇ ℓ ( {w}_{{t}_{i}} , z ) \cdot ∇ ℓ ( {w}_{{t}_{i}} , {z}^{′} ) \qquad ( 4 )$$

wherein ηᵢ represents a learning rate of the target model 420.

In some embodiments, the analysis device 120 may further determine, as the low-quality samples 130, negative-impact corrupted samples from the sample set 110 based on the impact similarity 430. As an example, the analysis device 120 determines multiple corrupted samples from the sample set 110 based on prior knowledge and compare the impact similarity 430 of the multiple corrupted samples with a threshold. For example, samples with the impact similarity 430 less than the threshold may be determined as negative-impact corrupted samples.

In some embodiments, the larger impact similarity 430 means that there is a large similarity between the impact of the sample in the target model 420 and the impact of the verification sample set 410 on the target model 420. Since the impact of the verification sample set 410 on the target model 420 is positive, the smaller impact similarity 430 may indicate that the impact of the sample on the target model 420 might be negative. Since some corrupted samples can exert a positive impact on the target model 420, in this way, embodiments of the present disclosure may further screen out negative-impact corrupted samples having a negative impact on the model.

In some embodiments, the analysis device 120 may further exclude possible negative-impact corrupted samples from the sample set, thereby obtaining normal samples for training or re-training the target model 420 or other model.

In the above-discussed way, embodiments of the present disclosure can screen out possible negative-impact corrupted samples only by using the training process of the sample set, which does not rely on high-quality training data for training the target model in advance. This can reduce the requirement on the cleanliness of training data and thus increase the universality of the method.

### Example Process

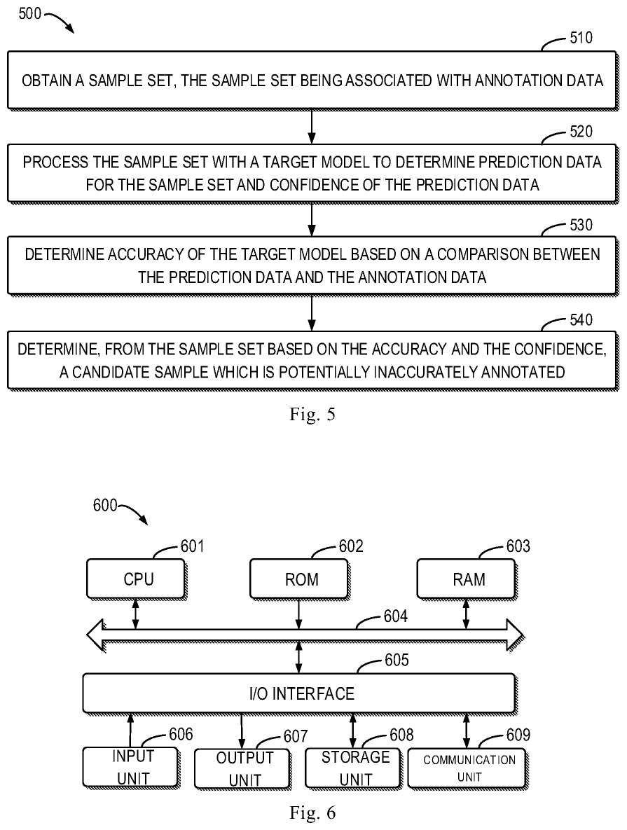

FIG. 5 shows a flowchart of a process 500 for sample analysis according to some embodiments of the present disclosure. The process 500 may be performed by the analysis device 120 in FIG. 1.

As shown in FIG. 5, at block 510, the analysis device 120 obtains a sample set, the sample set being associated with annotation data. At block 520, the analysis device 120 processes the sample set with a target model to determine prediction data for the sample set and confidence of the prediction data. At block 530, the analysis device 120 determines accuracy of the target model based on a comparison between the prediction data and the annotation data. At block 540, the analysis device 120 determines, from the sample set based on the accuracy and the confidence, a candidate sample which is potentially inaccurately annotated.

In some embodiments, the target model is trained with the sample set and the annotation data.

In some embodiments, the target model is trained through: training the target model with the sample set and the annotation data to divide the sample set into a first sample sub-set and a second sample sub-set; and re-training, based on semi-supervised learning, the target model with annotation data of the first sample sub-set as well as the second sample sub-set, without considering annotation data of the second sample sub-set.

In some embodiments, training the target model with the sample set and the annotation data to divide the sample set into a first sample sub-set and a second sample sub-set comprises: training the target model with the sample set and the annotation data to determine an uncertainty metric associated with the sample set; and dividing the sample set into the first sample sub-set and the second sample sub-set based on the uncertainty metric.

In some embodiments, training the target model with the sample set and the annotation data to divide the sample set into a first sample sub-set and a second sample sub-set comprises: training the target model with the sample set and the annotation data to determine a training loss associated with the sample set; and processing the training loss associated with the sample set with a classifier to divide the sample set into the first sample sub-set and the second sample sub-set.

In some embodiments, determining a candidate sample from the sample set comprises: determining a target number based on the accuracy and the number of samples in the sample set; and determining the target number of candidate samples from the sample set based on the confidence.

In some embodiments, the annotation data comprises at least one of a target category label, a task category label and a behavior category label associated with the sample set.

In some embodiments, the sample set comprises multiple image samples, and the annotation data indicates a category label of an image sample.

In some embodiments, a sample in the sample set comprises at least one object, and the annotation data comprises annotation information for the at least one object.

In some embodiments, the confidence is determined based on a difference between the prediction data and corresponding annotation data.

In some embodiments, the method further comprises: providing sample information associated with the candidate sample so as to indicate that the candidate sample is potentially inaccurately annotated.

In some embodiments, the method further comprises: obtaining feedback information for the candidate sample; and updating annotation data of the candidate sample based on the feedback information.

### Example Device

FIG. 6 shows a schematic block diagram of an example device 600 suitable for implementing implementations of the present disclosure. For example, the analysis device 120 as shown in FIG. 1 may be implemented by the device 600. As depicted, the device 600 comprises a central processing unit (CPU) 601 which is capable of performing various appropriate actions and processes in accordance with computer program instructions stored in a read only memory (ROM) 602 or computer program instructions loaded from a storage unit 608 to a random access memory (RAM) 603. In the RAM 603, there are also stored various programs and data required by the device 600 when operating. The CPU 601, the ROM 602 and the RAM 603 are connected to one another via a bus 604. An input/output (I/O) interface 605 is also connected to the bus 604.

Multiple components in the device 600 are connected to the I/O interface 605: an input unit 606 including a keyboard, a mouse, or the like; an output unit 607, such as various types of displays, a loudspeaker or the like; a storage unit 608, such as a disk, an optical disk or the like; and a communication unit 609, such as a LAN card, a modem, a wireless communication transceiver or the like. The communication unit 609 allows the device 600 to exchange information/data with other device via a computer network, such as the Internet, and/or various telecommunication networks.

The above-described procedures and processes, e.g., the process 500 may be executed by the processing unit 601. For example, in some implementations, the process 500 may be implemented as a computer software program, which is tangibly embodied on a machine readable medium, e.g. the storage unit 608. In some implementations, part or the entirety of the computer program may be loaded to and/or installed on the device 600 via the ROM 602 and/or the communication unit 609. The computer program, when loaded to the RAM 603 and executed by the CPU 601, may execute one or more acts of the process 500 as described above.

The present disclosure may be a method, an apparatus, a system, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some implementations, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to implementations of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer-implemented process, such that the instructions which are executed on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various implementations of the present disclosure have been presented for purposes of illustration, but are not intended to be exhaustive or limited to implementations disclosed. Many modifications and variations will be apparent to those of ordinary skill in the art without departing from the scope and spirit of the described implementations. The terminology used herein was chosen to best explain the principles of implementations, the practical application or technical improvement over technologies found in the marketplace, or to enable others of ordinary skill in the art to understand implementations disclosed herein.

I/We claim:

1. A method for sample analysis, comprising:
obtaining a sample set, the sample set being associated with annotation data;
processing the sample set with a target model to determine prediction data for the sample set and confidence of the prediction data;
determining accuracy of the target model based on a comparison between the prediction data and the annotation data; and
determining, from the sample set based on the accuracy and the confidence, a candidate sample which is potentially inaccurately annotated.

2. The method according to claim 1, wherein the target model is trained with the sample set and the annotation data.

3. The method according to claim 1, wherein the target model is trained through:
training the target model with the sample set and the annotation data to divide the sample set into a first sample sub-set and a second sample sub-set; and
re-training, based on semi-supervised learning, the target model with annotation data of the first sample sub-set as well as the second sample sub-set, without considering annotation data of the second sample sub-set.

4. The method according to claim 3, wherein training the target model with the sample set and the annotation data to divide the sample set into a first sample sub-set and a second sample sub-set comprises:
training the target model with the sample set and the annotation data to determine an uncertainty metric associated with the sample set; and
dividing the sample set into the first sample sub-set and the second sample sub-set based on the uncertainty metric.

5. The method according to claim 3, wherein training the target model with the sample set and the annotation data to divide the sample set into a first sample sub-set and a second sample sub-set comprises:
training the target model with the sample set and the annotation data to determine a training loss associated with the sample set; and
processing the training loss associated with the sample set with a classifier to divide the sample set into the first sample sub-set and the second sample sub-set.

6. The method according to claim 1, wherein determining the candidate sample from the sample set comprises:
determining a target number based on the accuracy and the number of samples in the sample set; and
determining the target number of candidate samples from the sample set based on the confidence.

7. The method according to claim 1, wherein the annotation data comprises at least one of a target category label, a task category label and a behavior category label associated with the sample set.

8. The method according to claim 1, wherein the sample set comprises multiple image samples, and the annotation data indicates a category label of an image sample.

9. The method according to claim 1, wherein a sample in the sample set comprises at least one object, and the annotation data comprises annotation information for the at least one object.

10. The method according to claim 1, wherein the confidence is determined based on a difference between the prediction data and corresponding annotation data.

11. The method according to claim 1, further comprising:
providing sample information associated with the candidate sample to indicate that the candidate sample is potentially inaccurately annotated.

12. The method according to claim 1, further comprising:
obtaining feedback information for the candidate sample; and
updating annotation data of the candidate sample based on the feedback information.

13. An electronic device, comprising:
at least one processing unit; and
at least one memory, coupled to the at least one processing unit and storing instructions for execution by the at least one processing unit, the instructions, when executed by the at least one processing unit, causing the device to perform acts, comprising:
obtaining a sample set, the sample set being associated with annotation data;
processing the sample set with a target model to determine prediction data for the sample set and confidence of the prediction data;
determining accuracy of the target model based on a comparison between the prediction data and the annotation data; and
determining, from the sample set based on the accuracy and the confidence, a candidate sample which is potentially inaccurately annotated.

14. The electronic device according to claim 13, wherein the target model is trained with the sample set and the annotation data.

15. The electronic device according to claim 13, wherein the target model is trained through:
training the target model with the sample set and the annotation data to divide the sample set into a first sample sub-set and a second sample sub-set; and
re-training, based on semi-supervised learning, the target model with annotation data of the first sample sub-set as well as the second sample sub-set, without considering annotation data of the second sample sub-set.

16. The electronic device according to claim 15, wherein training the target model with the sample set and the annotation data to divide the sample set into a first sample sub-set and a second sample sub-set comprises:
training the target model with the sample set and the annotation data to determine an uncertainty metric associated with the sample set; and
dividing the sample set into the first sample sub-set and the second sample sub-set based on the uncertainty metric.

17. The electronic device according to claim 15, wherein training the target model with the sample set and the annotation data to divide the sample set into a first sample sub-set and a second sample sub-set comprises:
training the target model with the sample set and the annotation data to determine a training loss associated with the sample set; and
processing the training loss associated with the sample set with a classifier to divide the sample set into the first sample sub-set and the second sample sub-set.

18. The electronic device according to claim 13, wherein determining the candidate sample from the sample set comprises:
determining a target number based on the accuracy and the number of samples in the sample set; and
determining the target number of candidate samples from the sample set based on the confidence.

19. The electronic device according to claim 13, wherein the annotation data comprises at least one of a target category label, a task category label and a behavior category label associated with the sample set.

20. A non-transitory computer-readable storage medium, having computer-readable program instructions stored thereon, the computer-readable program instructions being used for performing a method for sample analysis, the method comprising:
obtaining a sample set, the sample set being associated with annotation data;
processing the sample set with a target model to determine prediction data for the sample set and confidence of the prediction data;
determining accuracy of the target model based on a comparison between the prediction data and the annotation data; and
determining, from the sample set based on the accuracy and the confidence, a candidate sample which is potentially inaccurately annotated.
